(19) United States
(12) Patent Application Publication
(10) Pub. No.: US 2018/0054300 A1
(43) Pub. Date: Feb. 22, 2018

(54) CODING AND ENCRYPTION FOR WAVELENGTH DIVISION MULTIPLEXING VISIBLE LIGHT COMMUNICATIONS

(71) Applicant: Alcetel Lucent, Boulogne- Billancourt (FR)

(72) Inventor: Yejian CHEN, Stuttgart (DE)

(73) Assignee: Alcetel Lucent, Boulogne- Billancourt (FR)

(21) Appl. No.: 15/560,587

(22) PCT Filed: Feb. 1, 2016
(86) PCT No.: PCT/EP2016/052084

§ 371 Date: Sep. 22, 2017

(30) Foreign Application Priority Data
Apr. 2, 2015 (EP) 15290090.8

(51) Int. Cl. H04L 9/06; H04B 10/116; H04B 10/50

(52) U.S. Cl. CPC H04L 9/065; H04J 14/0202; H04B 10/50; H04B 10/116

(57) ABSTRACT

The method includes a first encryption step of encrypting each of a plurality of data streams to obtain a respective encrypted data stream, a mapping step of mapping the plurality of encrypted data streams obtained in the first encryption step to a plurality of transmission streams for transmission via the optical transmission units, wherein the transmission streams and optical transmission units are in a one-to-one relationship, and wherein each transmission stream is mapped to by at least two of the plurality of encrypted data streams. The method further includes a second encryption step of encrypting each of the plurality of transmission streams to obtain a respective encrypted transmission stream, and a transmission step of transmitting each of the plurality of encrypted transmission streams obtained in the second encryption step via a respective optical transmission unit.

### TECHNICAL FIELD

This application relates to transmitters arid receivers for transmitting multiple data streams via optical communication using wavelength division multiplexing (WDM), and to methods of transmitting and receiving multiple data streams via optical communication using WDM. The application particularly relates to transmission and reception of multiple data streams via visible light communication (VLC) using WDM.

### BACKGROUND

VLC is growing area of wireless telecommunications and is recognized as a ₅G technique. It does not require complicated infrastructure, and may be typically employed in Device-to-Device (D2D) communication, vehicle communication, and indoor/outdoor wireless communication.

In general, VLC is a rather secure communication concept, since the receiver is required to have Light-of-Sight (LoS) connection to the transmitter. Thus, also a potential eavesdropper would need to have a LoS connection to the transmitter and hence would in principle be visible to the transmitter. Nevertheless, in order to ensure detectability of the potential eavesdropper, VLC is typically employed in indoor broadcasting or in fields of application for which the transmitted signal or information is public, i.e. which have low security priority.

A technique for increasing security of VLC includes transmitting scrambled visible light signals between the transmitter and receiver instead of the original data, and to vary the scrambling sequence from time to time. In other words, the visible light signal is encrypted/decrypted in the time domain according to this technique. Nevertheless, the visible light signal may be received and stored by a potential eavesdropper, and the scrambling sequence and its generating algorithm might be determined subsequently.

According to another technique for increasing security of VLC, a secure space-time encryption and decryption mechanism is employed for Multiple Input Multiple Output (MIMO)-VLC, in which multiple LED transceivers are required to support MIMO-VLC. Here, the improved level of security due to encryption and decryption via on-off switching of the LEDs is attained at the price of a not fully used space-time resource.

However, there is still a need for an improved technique for improving security of VLC.

### SUMMARY

In view of this need, the present document proposes a method of transmitting multiple data streams via multiple optical transmission units adapted for optical communication using WDM, a method of receiving multiple data streams via multiple optical reception units adapted for optical communication using WDM, a transmission device for transmitting multiple data streams via multiple optical transmission units adapted for optical communication using WDM, and a reception device for receiving multiple data streams via multiple optical reception units adapted for optical communication using WDM, having the features of the respective independent claims.

An aspect of the disclosure relates to a method of transmitting multiple data streams via multiple optical transmission units adapted for optical communication using wavelength division multiplexing. Said optical communication may be visible light communication. Further, said optical communication may be free-space optical communication. Transmission may be performed at mutually different wavelengths. The method may comprise a first encryption step of encrypting each of a plurality of data streams to obtain a respective encrypted data stream. The first encryption step may involve scrambling each of the plurality of data streams, or encrypting each of the plurality of data streams by using an encryption algorithm. The method may further comprise a (symbol) mapping step of mapping the plurality of encrypted data streams obtained in the first encryption step to a plurality of transmission streams for transmission via the optical transmission units. The transmission streams and optical transmission units may be in a one-to-one relationship, i.e. for each transmission stream there may be a corresponding optical transmission unit. Each transmission stream may be mapped to by at least two of the plurality of encrypted data streams, i.e. may receive contributions from at least two of the plurality of encrypted data streams. The method may further comprise a second encryption step of encrypting each of the plurality of transmission streams to obtain a respective encrypted transmission stream. The second encryption step may involve scrambling each of the plurality of transmission streams, or encrypting each of the plurality of transmission streams by using an encryption algorithm. The method may further comprise a transmission step of transmitting each of the plurality of encrypted transmission streams obtained in the second encryption step via a respective optical transmission unit. The optical transmission units may be LEDs. The multiple LEDs (e.g. colored LEDs) may transmit (emit) light at mutually different wavelengths. The method may yet further comprise an encoding step, before the first encryption step, of encoding a plurality of input data streams for optical transmission.

The data streams, encrypted data streams, transmissions streams and encrypted transmissions stream defined in the present disclosure may be collectively referred to as streams of symbols, or symbols streams. Throughout the present disclosure, scrambling of a stream of symbols may be understood to relate to (inter)changing positions of symbols within the stream of symbols, or to introducing phase shifts, e.g. (pseudo-)random phase shifts, to the symbols of the stream of symbols. Likewise, un-scrambling of a stream of symbols may be understood to relate to (inter)changing positions of symbols within the stream on symbols to reverse the effect of the scrambling, or to introducing appropriate phase shifts to the symbols of the stream of symbols to compensate for any phases introduced during the scrambling. Further, encryption algorithms and decryption algorithms referred to in the present disclosure may relate e.g. to symmetrical encryption/decryption algorithms, such as algorithms according to the Data Encryption Standard (DES) or Advanced Encryption Standard (AES), for example, or to asymmetrical encryption/decryption algorithms, such as the Rivest-Shamir-Adleman (RSA) algorithm or the Pretty Good Privacy (PGP) algorithm, for example. However, the present disclosure is not limited to these examples of encryption/decryption algorithms, and any suitable encryption/decryption algorithm may be used.

Recently, it has been recognized that WDM can be jointly embedded in an optical communication system, such as a VLC system, by using the inherent frequency gap of colored LEDs to enable simultaneous transmission of multiple optical signals. Configured as above, the transmission method provides for an enhanced transmission bandwidth by virtue of WDM, and further provides for a significantly enhanced level of security compared to conventional optical communication. Successfully recovering the transmitted data requires knowledge of all three of the first and second encryptions schemes and the mapping scheme. In this sense, the mapping step may be understood to present a third encryption layer. While performing the combination of encryption steps and the mapping step proposed above does not unduly increase computational burden on the transmitter or a legitimate receiver, computational burden for illegitimately recovering the transmitted data by a potential eavesdropper is drastically increased. In other word, the above combination of encryption and mapping steps allows to protect the transmitted data against eavesdropping by non-authorized third parties, and at the same time to fully exploit the diversity of different WDM channels. In addition, a signal-to-noise ratio (SNR) of optical transmission may be improved by the proposed combination of encryption and mapping steps.

In embodiments, the plurality of data streams may be encrypted individually in the first encryption step, using a distinct encryption scheme (e.g. scrambling sequence, or encryption key) for each data stream. Thus, if the plurality of data streams corresponds to a plurality of different users, confidentiality of information among the plurality of users is achieved in a simple manner.

In embodiments, each transmission stream may be obtained as an interleaved sequence of data portions of at least two of the plurality of encrypted data streams in the mapping step. In other words, each transmission stream may be (virtually) divided into a plurality of sequential slots (e.g. blocks) in the time domain, and for each of these slots, a data portion (e.g. block) of one of the plurality of encrypted data streams may be selected for providing the content of the respective slot. This mapping may be performed in accordance with a predetermined mapping scheme. This predetermined mapping scheme may be shared with a receiver side. Further, the predetermined mapping scheme may be varied over time. Since the mapping relates to scrambling of symbols or blocks of symbols in the frequency domain, it may be understood to provide another layer of encryption in addition to the first and second encryption steps.

In embodiments, each of the plurality of encrypted data streams may be mapped to each of the plurality of transmission streams in the mapping step. Further, the number of (encrypted) data streams may be equal to the number of transmission streams, and hence equal to the number of optical transmission units. In other words, the mapping may be diagonal mapping. Thus, each transmission stream may comprise a data portion of each encrypted data stream, and each transmission stream may be obtained as an interleaved sequence of data portions of each of the plurality of encrypted data streams. Thereby, diversity of WDM channels can be exploited in an optimal manner.

Another aspect of the disclosure relates to a method of receiving multiple encrypted transmission streams via multiple optical reception units adapted for optical communication using wavelength division multiplexing. Said optical communication may be visible light communication. Further, said optical communication may be free-space optical communication. Reception may be performed at mutually different wavelengths. The method may comprise a reception step of receiving a plurality of encrypted transmission streams at a plurality of optical reception units. The received encrypted transmission streams and the optical reception units may be in a one-to-one relationship, i.e. for each encrypted transmission stream there may be a corresponding optical reception unit. The optical reception units may be photodetectors. The multiple photodetectors may be sensitive to light of mutually different wavelengths. The method may comprise a first decryption step of decrypting each of the plurality of encrypted transmission streams to obtain a respective transmission stream. The first decryption step may be the inverse of the second encryption step of the method for transmitting multiple data streams according to the preceding aspect. The first decryption step may involve un-scrambling each of the plurality of encrypted transmission streams or decrypting each of the plurality of encrypted transmission streams by using a decryption algorithm. The method may comprise a mapping step of mapping the plurality of transmission streams obtained in the first decryption step to a plurality of encrypted data streams. Each transmission stream may be mapped to at least two of the plurality of encrypted data streams. The mapping step may be the inverse of the mapping step of the method for transmitting multiple data streams according to the preceding aspect. The method may comprise a second decryption step of decrypting each of the plurality of encrypted data streams to obtain a respective data stream. The second decryption step may be the inverse of the first encryption step of the method for transmitting multiple data streams according to the preceding aspect. The second decryption step may involve un-scrambling each of the plurality of encrypted data streams or decrypting each of the plurality of encrypted data streams by using a decryption algorithm. The method may further comprise a decoding step, after the second decryption step, of decoding each of the plurality of data streams obtained in the second decryption step to obtain a respective decoded data stream. The method may yet further comprise an outputting step of outputting the plurality of decoded data streams obtained in the decoding step, or the plurality of data streams obtained in the second decoding step, to one or more users.

In embodiments, the plurality of encrypted data streams may be decrypted individually in the second decryption step, using a distinct decryption scheme for each encrypted data stream. Each distinct decryption scheme (e.g. scrambling sequence or decryption key) may correspond to a respective encryption scheme used for obtaining the respective encrypted data stream at a transmitter side.

In embodiments, each encrypted data stream may be obtained as an interleaved sequence of data portions of the plurality of transmission streams in the mapping step, such that for each transmission stream at least two of the plurality of encrypted data streams contain a data portion of the respective transmission stream. In other words, each transmission stream may be divided into a plurality of sequential slots (e.g. blocks) in the time domain in accordance with a division of the respective transmission stream at the transmitter side, and for each of these slots, one of the plurality of encrypted data streams may be selected for receiving the content of the respective slot. Each of the plurality of encrypted data streams may be mapped to by each of the plurality of transmission streams. Further, the number of (encrypted) data streams may be equal to the number of transmission streams, and hence equal to the number of optical reception units. In other words, the mapping may be diagonal mapping. Thus, each encrypted data stream may comprise a data portion of each transmission stream, and each encrypted data stream may be obtained as an interleaved sequence of data portions of each of the plurality of transmission streams. This mapping may be performed in accordance with a predetermined mapping scheme, which may be the inverse of a mapping scheme used at the transmitter side. In other words, the predetermined mapping scheme may be shared between the transmitter side and the receiver side.

Another aspect of the disclosure relates to a transmission device for transmitting multiple data streams via multiple optical transmission units adapted for optical communication using wavelength division multiplexing. Said optical communication may be visible light communication. Further, said optical communication may be free-space optical communication. Transmission may be performed at mutually different wavelengths. The transmission device may comprise a first encryption unit for encrypting each of a plurality of data streams to obtain a respective encrypted data stream. The first encryption unit may be configured to perform scrambling of each of the plurality of data streams or encrypting each of the plurality of data streams by using an encryption algorithm. The transmission device may further comprise a mapping unit for mapping the plurality of encrypted data streams obtained by the first encryption unit to a plurality of transmission streams for transmission via the optical transmission units. The transmission streams and optical transmission units may be in a one-to-one relationship, i.e. for each transmission stream there may be a corresponding optical transmission unit. Each transmission stream may be mapped to by at least two of the plurality of encrypted data streams, i.e. may receive contributions from at least two of the plurality of encrypted data streams. The transmission device may further comprise a second encryption unit for encrypting each of the plurality of transmission streams to obtain a respective encrypted transmission stream. The second encryption unit may be configured to perform scrambling of each of the plurality of transmission streams or encrypting each of the plurality of transmission streams by using an encryption algorithm. The transmission device may further comprise a transmission unit for transmitting each of the plurality of encrypted transmission streams obtained by the second encryption unit. The transmission unit may comprise the multiple optical transmission units. Each encrypted transmission stream may be transmitted via a respective optical transmission unit. The optical transmission units may be LEDs (optical diodes). The multiple LEDs may transmit (emit) light at mutually different wavelengths. The transmission device may yet further comprise an encoding unit for encoding a plurality of input data streams for optical transmission.

In embodiments, the first encryption unit may be configured to encrypt the plurality of data streams individually, using a distinct encryption scheme (e.g. scrambling sequence or encryption key) for each data stream.

In embodiments, the mapping unit may be configured to generate each transmission stream by sequentially interleaving data portions of at least two of the encrypted data streams. In other words, each transmission stream may be (virtually) divided into a plurality of sequential slots (e.g. blocks) in the time domain, and for each of these slots, a data portion (e.g. block) of one of the plurality of encrypted data streams may be selected for providing the content of the respective slot. This mapping may be performed in accordance with a predetermined mapping scheme. This predetermined mapping scheme may be shared with a receiver side.

In embodiments, the mapping unit may be configured to map each of the plurality of encrypted data streams to each of the plurality of transmission streams. Further, the number of (encrypted) data streams may be equal to the number of transmission streams, and hence equal to the number of optical transmission units. In other words, the mapping may be diagonal mapping. Thus, each transmission stream may comprise a data portion of each encrypted data stream, and each transmission stream may be obtained as an interleaved sequence of data portions of each of the plurality of encrypted data streams.

In embodiments, the transmission device may further comprise one or more connection ports for connecting one or more user devices. Each of these user devices may be configured to input one or more (input) data streams to the transmission device.

Another aspect of the disclosure relates to a reception device for receiving multiple encrypted transmission streams via a plurality of optical reception units adapted for optical communication using wavelength division multiplexing. Said optical communication may be visible light communication. Further, said optical communication may be free-space optical communication. Reception may be performed at mutually different wavelengths. The reception device may comprise a reception unit for receiving a plurality of encrypted transmission streams. The reception unit may comprise the plurality of optical reception units, and reception may be performed at the plurality of optical reception units. The optical reception units may be photodetectors. The multiple photodetectors may be sensitive to light of mutually different wavelengths. The encrypted transmission streams and the optical reception units may in a one-to-one relationship, i.e. for each encrypted transmission stream there may be a corresponding optical reception unit. The reception device may further comprise a first decryption unit for decrypting each of the plurality of encrypted transmission streams to obtain a respective transmission stream. The first decryption unit may be configured to perform decryption in an inverse relationship to encryption performed by the second encryption unit of the transmission device according to the preceding aspect. The first decryption unit may be configured to perform un-scrambling of each of the plurality of encrypted transmission streams or decrypting each of the plurality of encrypted transmission streams by using a decryption algorithm. The reception device may further comprise a mapping unit for mapping the plurality of transmission streams obtained by the first decryption unit to a plurality of encrypted data streams. Each encrypted data stream may be mapped to by at least two of the plurality of transmission streams. The mapping unit may be configured to perform mapping in an inverse relationship to the mapping performed by the mapping unit of the transmission device according to the preceding aspect. The reception device may further comprise a second decryption unit for decrypting each of the plurality of encrypted data streams to obtain a respective data stream. The second decryption unit may be configured to perform decryption in an inverse relationship to encryption performed by the first encryption unit of the transmission device according to the preceding aspect. The second decryption unit may be configured to perform un-scrambling of each of the plurality of encrypted data streams or decrypting each of the plurality of encrypted data streams by using a decryption algorithm. The reception device may further comprise a decoding unit for decoding each of the plurality of data streams obtained by the second decryption unit to obtain a respective decoded data stream. The reception device may yet further comprise an output unit for outputting the plurality of decoded data streams obtained by the decoding unit, or the plurality of data streams obtained by the second decoding unit, to one or more users.

In embodiments, the second decryption unit may be configured to decrypt the plurality of encrypted data streams individually, using a distinct decryption scheme for each encrypted data stream.

In embodiments, the mapping unit may be configured to generate each encrypted data stream by sequentially interleaving data portions of the transmission streams, such that for each transmission stream at least two of the plurality of encrypted data streams contain a data portion of the respective transmission stream. In other words, each transmission stream may be divided into a plurality of sequential slots (e.g. blocks) in the time domain in accordance with a division of the respective transmission stream at the transmitter side, and for each of these slots, one of the plurality of encrypted data streams may be selected for receiving the content of the respective slot. Each of the plurality of encrypted data streams may be mapped to by each of the plurality of transmission streams, i.e. each of the plurality of encrypted data streams may receive a contribution from each of the plurality of transmission streams. Further, the number of (encrypted) data streams may be equal to the number of transmission streams, and hence equal to the number of optical reception units. In other words, the mapping may be diagonal mapping. Thus, each encrypted data stream may comprise a data portion of each transmission stream, and each encrypted data stream may be obtained as an interleaved sequence of data portions of each of the plurality of transmission streams. This mapping may be performed in accordance with a predetermined mapping scheme, which may be the inverse of a mapping scheme used at the transmitter side. In other words_{;} the predetermined mapping scheme may be shared between the transmitter side and the receiver side.

In embodiments, each optical reception unit may comprise a photodetector and an optical filter. The optical filter may be arranged such that light interacting with the photodetector must have passed through the optical filter. The optical filters of the plurality of optical reception units may have mutually different pass bands.

In embodiments, the reception device may further comprise one or more connection ports for connecting one or more user devices. Each of these user devices may be configured to receive one or more data streams from the reception device.

Another aspect of the disclosure relates to an apparatus comprising the transmission device and the reception device according to the two preceding aspects.

It will be appreciated that method steps and apparatus features may be interchanged in many ways. In particular, the details of the disclosed apparatus can be implemented as a method, and vice versa, as the skilled person will appreciate.

### BRIEF DESCRIPTION OF THE FIGURES

Embodiments of the disclosure are explained below in an exemplary manner with reference to the accompanying drawings, wherein

FIG. 1 schematically illustrates an example of a VLC system to which embodiments of the disclosure may be applied,

FIG. 2A schematically illustrate a conventional mapping scheme,

FIG. 2B schematically illustrates an example of a mapping scheme that may be employed in embodiments of the disclosure,

FIG. 3 is a flow chart schematically illustrating an example of a transmission method according to embodiments of the disclosure,

FIG. 4A and FIG. 4B schematically illustrate examples of transmission devices according to embodiments of the disclosure,

FIG. 5 is a flow chart schematically illustrating an example of a reception method according to embodiments of the disclosure,

FIG. 6 schematically illustrates an example of an integrated device for transmission and reception according to embodiments of the disclosure, and

FIG. 7 schematically illustrates an example of a reception device according to embodiments of the disclosure.

### DETAILED DESCRIPTION

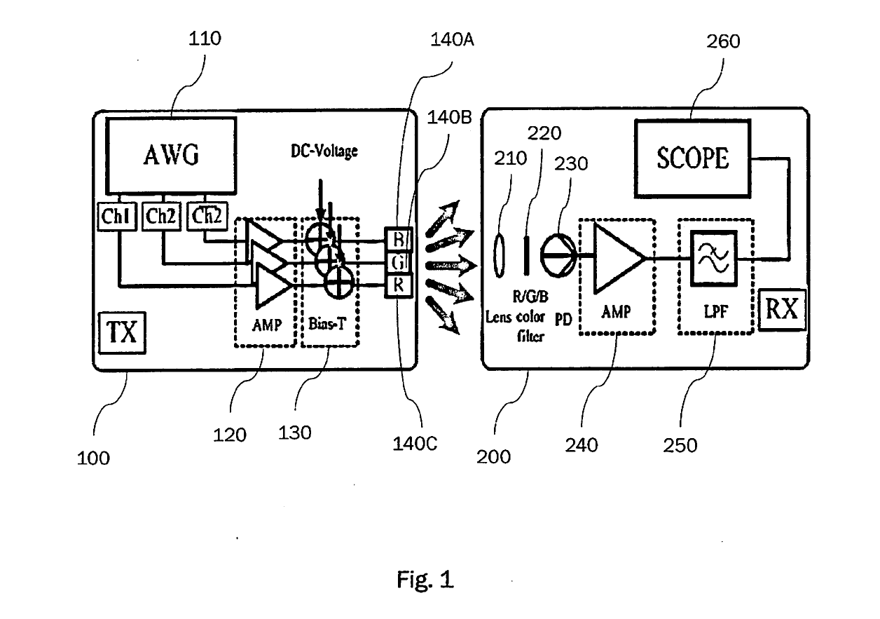

It has been found that WDM can be jointly embedded in a VLC system by using inherent frequency gaps of colored LEDs to enable simultaneous transmission of multiple signals. FIG. 1 schematically illustrates examples of a transmitter (e.g. a VLC transmitter) 100 and a receiver (e.g. a VLC receiver) 200 employing WDM.

In the transmitter 100, a plurality of data streams are generated. This proceeds e.g. via an Arbitrary Waveform Generator (AWG) 110 outputting a plurality of signals. The plurality of signals may be (individually) amplified by an amplifier 120 comprising an amplification stage for each signal. The plurality of amplified signals may then be input to a bias unit 130 which impresses each signal in accordance with data to be transmitted, thereby generating the plurality of data streams. The data streams may be encoded for optical transmission by an encoder unit (not shown in the figure). The (encoded) data streams may be transmitted via optical transmission units 140A, 140B, 140C. The optical transmission units 140A, 140B, 140C may be LEDs (optical diodes) that emit light at mutually different wavelengths.

The receiver 200 may comprise a lens 210, a plurality of optical filters (color filters) 220, a plurality of photodetectors 230, an amplifier 240, a filter (e.g. a low pass filter) 250, and a decoding unit 260. The optical filters 220 may have mutually different pass bands, i.e. each optical filter may allow passage of a distinct wavelength or range of wavelengths, while blocking all other wavelengths. Each optical filter 220 may be arranged in conjunction with a corresponding photodetector 230. After focusing be the lens 210, the received optical signals may be optically filtered by the optical filters 220 and converted into electrical signals at corresponding photodetectors 230. After filtering at the filter 250, decoding may be performed in the decoding unit 260.

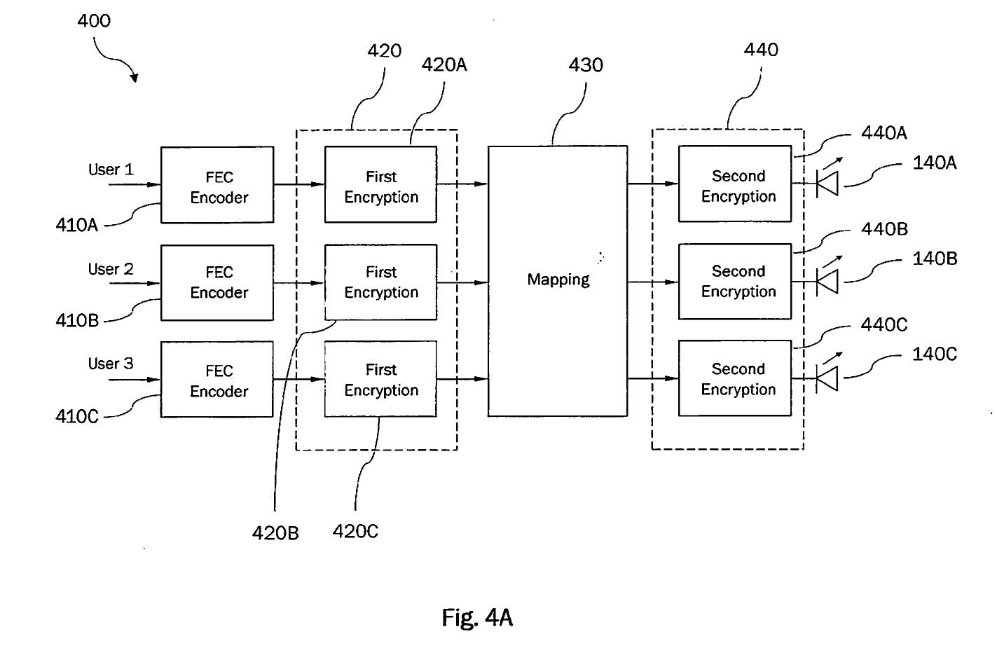

Using the optical communication system of FIG. 3, the data throughput is enhanced by a factor corresponding to the number of data streams (e.g. three in the illustrated example). In order to avoid interference of spatially adjacent channels, and in order to enhance security, Forward Error Correction (FEC) and encryption schemes may be employed. The former aids the target user (receiver) to recover the signal successfully, and the latter prevents eavesdropping by third parties.

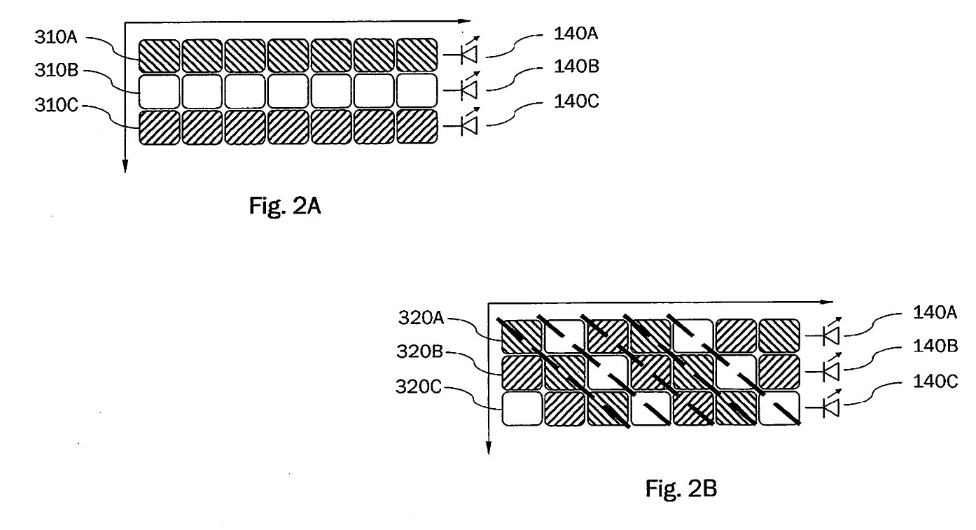

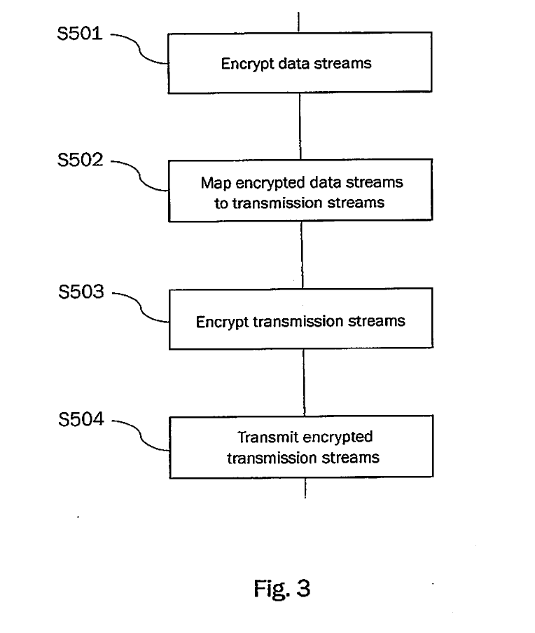

FIG. 2A schematically illustrates a conventional mapping scheme. This scheme corresponds to horizontal mapping, as described e.g. in T. A. Khan et al., “Visible Light Communication using Wavelength Division Multiplexing for Smart Spaces”, in Proceedings of the ₉th Annual IEEE Consumer Communications and Networking Conference (CCNC'12), Jan. 2012. For example, three (7,4)-Bose-Chaudhuri-Hocquenghem (BCH)-Codes 310A, 310B, 310C (data streams) may be independently transmitted via Red (R), Green (G), and Blue (B) channels, using optical transmission units 140A, 140B, 140C. In the figure, the horizontal axis represents time, and the vertical axis indicates wavelength or frequency of emitted light.

FIG. 2B schematically illustrates an example of a mapping scheme that may be employed in embodiments of the disclosure.

A plurality of data streams may be individually encoded for optical transmission, e.g. as (7,4)-BCH-Codes. Any suitable encoding scheme may be used at this stage. Further, depending on the data streams that are received as an input, encoding may not be required. Each data stream may be obtained from an individual user of a multi-user WDM-VLC system, or all data streams may be obtained from a single user. Also combinations of these two extremal cases are possible.

The plurality of (encoded) data streams may be subjected to (first) encryption, e.g. by scrambling of symbols in the (encoded) data streams or by encrypting the (encoded) data streams using an appropriate encryption algorithm. Scrambling is understood to involve interchanging positions of symbols in a respective stream, or introducing phase shifts into a respective stream, e.g. according to a scrambling sequence generated by a generating algorithm. The symbol positions may be changed in a (pseudo-)random manner, and the phase shifts may be pseudo-random phase shifts. The scrambling sequence (scrambling scheme, encryption algorithm, or encryption scheme in general) may be varied with time. Likewise, an encryption key may be varied with time. The data streams may be encrypted individually, i.e. each data stream may be encrypted according to a distinct encryption scheme (e.g. scrambling scheme, or encryption scheme in general). These encryption schemes may be confidential to both internal users (i.e. users providing the data streams) and external users.

After encryption, the encrypted data streams may be subjected to WDM, i.e. the encrypted data streams may be mapped to a plurality of data streams. For each optical transmission unit, there may be a corresponding transmission stream. That is, the numbers of optical transmission units and transmission streams may be equal, and the optical transmission units and transmission streams may be in a one-to-one relationship. The mapping may proceed according to a predetermined mapping scheme. Successful transmission (decoding) may require that the mapping scheme is known to the receiver side. In the mapping, each transmission stream may be obtained as an interleaved sequence of data portions of encrypted data streams (e.g. of at least two encrypted data streams). To this end, each transmission stream may be (virtually) divided into a plurality of sequential slots (e.g. corresponding to blocks) in the time domain. For each of these slots, a data portion (e.g. block) of one of the plurality of encrypted data streams may be selected for providing the content of the respective slot. Each slot or block may comprise a predetermined number of symbols. Put differently, blocks of the encrypted data streams may be distributed to the transmission streams. To avoid trivial mapping, each transmission stream may be mapped to by at least two encrypted data streams, i.e. each transmission stream may comprise contributions (data portions, e.g. blocks) from at least two different encrypted data streams. To ensure optimal utilization of time-frequency resources, the number of (encrypted) data streams may be equal to the number of transmission streams, and hence the number of (encrypted) data streams may be equal to the number of optical transmission units.

In general, for N encrypted data streams and N transmission streams, an m-th block of an n-th transmission stream corresponds to an m-th block of an encrypted data stream the number of which is given by a function F(n,m) which implements the mapping scheme. Said function may be known to the receiver side. The mapping scheme may be varied with time. Further, the mapping scheme may be said to present another layer of security (i.e. encryption).

A particular mapping scheme that may be employed in embodiments of the disclosure is diagonal mapping. However, the present disclosure is not to be understood to be limited to diagonal mapping. In diagonal mapping, each of the plurality of encrypted data streams may be mapped to each of the plurality of transmission streams in the mapping step. Since each encrypted data stream is mapped to each transmission stream, each transmission stream comprises contributions (data portions, e.g. blocks) of each encrypted data stream. Thus, each transmission stream may be obtained as an interleaved sequence of data portions of each of the plurality of encrypted data streams.

In more detail, in diagonal mapping a first block of a first transmission stream may correspond to a first block of a first encrypted data stream, a second block of the first transmission stream may correspond to a second block of a second encrypted data stream, and so forth. Further, a second block of the second transmission stream may correspond to a second block of the first encrypted data stream, a third block of the second transmission stream may correspond to a third block of the second encrypted data stream, and so forth. In other words, if diagonal mapping is employed, each transmission stream may be mapped to by each encrypted data stream in a cyclical manner. In general, for N encrypted data streams and N transmission streams, an m-th block of an n-th transmission stream corresponds to an m-th block of an (((n+m+1) mod N) +1)-th encrypted data stream.

When employing diagonal mapping, each data stream will be transmitted by each optical transmission unit, i.e. there are a plurality (three in the example of FIG. 2B) of independent channel realizations.

While mapping according to the present disclosure has been explained with reference to encrypted data streams and transmission streams, it is understood that the above description generalizes to any kind of input streams and any kind of output streams.

Subsequent to mapping, each transmission stream may be subjected to (second) encryption. Unless indicated otherwise, encryption at this stage may proceed as described above for encryption of the (encoded) data streams. The encryptions scheme (e.g. scrambling sequence or encryption key) may be varied with time. The transmission streams may be encrypted individually, i.e. transmission stream may be encrypted according to a distinct encryption scheme (e.g. scrambling sequence). The encryption schemes may be confidential to external users, but may be known to internal users (i.e. users providing the data streams).

As indicated above, it is the purpose of the first encryption to protect each individual user in the multi-user WDM-VLC system from eavesdropping, i.e. from eavesdropping by other internal users, and also from eavesdropping by third parties (external eavesdropping). Thus, (first) encryption information (encryption scheme, e.g. scrambling scheme or a key for encryption/decryption) may not be shared among the internal users of the multi-user WDM-VLC system. Further, it is the purpose of the second encryption to protect the internal users against external eavesdropping. Accordingly, (second) encryption information (encryption scheme, e.g. scrambling scheme or a key for encryption/decryption) may be shared among the internal users of the multi-user WDM-VLC system.

FIG. 3 is a flow chart schematically illustrating an example of a transmission method according to embodiments of the disclosure.

At step S501, which is a first encryption step, the plurality of data streams may be encrypted, as described with reference to FIG. 2B above. Encrypting the plurality of data streams may involve scrambling (symbols of) each of the plurality of data streams or encrypting each of the plurality of data streams using a suitable encryption algorithm. Each data stream may be encrypted using a unique (i.e. data stream specific) encryption scheme (e.g. scrambling scheme, or key). As an outcome of this step, a plurality of encrypted data streams are obtained.

Optionally, prior to step S501, an encoding step of encoding each of a plurality of data streams for optical transmission may be provided (not shown in FIG. 3).

At step S502, which is a mapping step, the encrypted data streams obtained at step S501 may be mapped to a plurality of transmission streams, as described with reference to FIG. 2B above.

The number of transmission streams may be equal to the number of optical transmission units and to the number of encrypted data streams. Each transmission stream may be mapped to by at least two encrypted data streams. If diagonal mapping is employed, each transmission stream may be mapped to by each encrypted data stream, in a cyclical manner. As an outcome of this step, a plurality of transmission streams are obtained.

At step S503, which is a second encryption step, each of the plurality of transmission streams may be encrypted, as described with reference to FIG. 2B above. Encrypting the plurality of transmission streams may involve scrambling (symbols of) each of the plurality of transmission streams or encrypting each of the plurality of transmissions streams using a suitable encryption algorithm. Each transmission stream may be encrypted using a unique (i.e. transmission stream specific) encryption scheme (e.g. scrambling scheme, or key). As an outcome of this step, a plurality of encrypted transmission streams are obtained.

At step S504, which is a transmission step, each of the plurality of encrypted transmission streams obtained at step S503 may be transmitted via a corresponding optical transmission unit. Each transmission stream may be transmitted as a corresponding optical signal. The optical transmission units may be colored LEDs (optical diodes) that emit light at mutually different wavelengths, such as red, green and blue LEDs, for example. Thus, each transmissions stream may be transmitted as a corresponding optical signal of a specific wavelength.

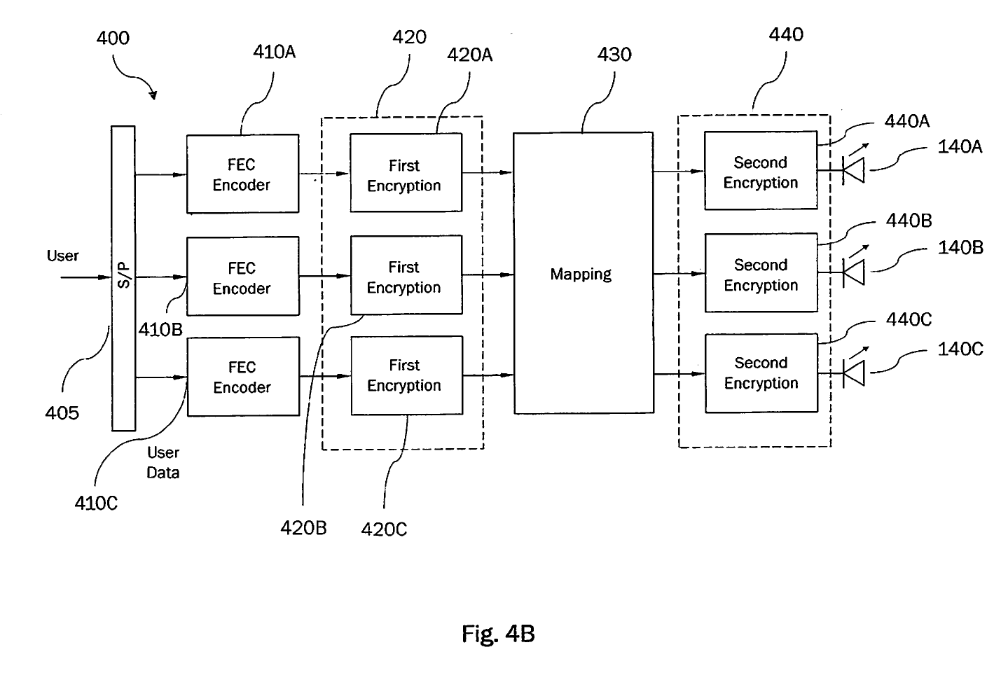

FIG. 4A and FIG. 4B schematically illustrate examples of transmission devices 400 according to embodiments of the disclosure. FIG. 4A relates to a multi-user case in which each user provides a data stream and FIG. 4B relates to a single-user case in which a single user provides a plurality of data streams, in order to profit from increased bandwidth for transmission.

A plurality of data streams e.g. provided by a plurality of individual users may be input to the transmission device 400 of FIG. 4A. The transmission device 400 may comprise a plurality of encoding units (e.g. FEC encoders) 410A, 410B, 410C, a first encryption unit 420, a mapping unit 430, a second encryption unit 440, and a plurality of optical transmission units 140A, 140B, 140C. The first encryption unit 420 may comprise a plurality of first encryption sub-units 420A, 420B, 420C, e.g. one first encryption sub-unit for each data stream. The second encryption unit 440 may comprise a plurality of second encryption sub-units 440A, 440B, 440C, e.g. one second encryption sub-unit for each transmission stream.

Each of the encoding units 410A, 410B, 410C may be configured to encode a corresponding data stream for optical transmission, e.g. using FEC encoding. The first encryption unit 420 may be configured to encrypt each of the plurality of data streams, as described above with reference to step S501. For example, each of the first encryption sub-units 420A, 420B, 420C of the first encryption unit 420 may be configured to encrypt a corresponding one of the plurality of data streams, e.g. by scrambling the corresponding data stream. The mapping unit 430 may be configured to perform the mapping described with reference to step S502. The second encryption unit 440 may be configured to encrypt each of the plurality of transmission streams, as described above with reference to step S503. For example, each of the second encryption sub-units 440A, 440B, 440C of the second encryption unit 440 may be configured to encrypt a corresponding one of the plurality of transmission streams, e.g. by scrambling the corresponding transmission stream. Each of the plurality of optical transmission units 140A, 140B, 140C may be configured to transmit a corresponding one of the plurality of encrypted transmission streams. Each optical transmission unit 140A, 140B, 140C may be a colored LED (optical diode). The colored LEDs may emit light at mutually different wavelengths, i.e. each colored LED may emit light at a distinct wavelength. The plurality of optical transmission units 140A, 140B, 140C may be comprised by a transmission unit of the transmitter device 400 (not shown in the figure).

The transmission device 400 illustrated in FIG. 4B is identical to the transmission device 400 illustrated in FIG. 4A, with the exception that it may additionally comprise a signal processing unit 405 for converting a single data stream provided by a user to a plurality of data streams, in accordance with a number of optical transmission units 140A, 140B, 140C of the transmission device 400. Notably, for N data streams, the data rate of the single data stream is an N-fold of the data rate of each of the plurality of data streams. Thus, the transmission device 400 in FIG. 4A may be said to support multi-user communications, while the transmission device of FIG. 4B may be said to support single-user communication with an enhanced bandwidth.

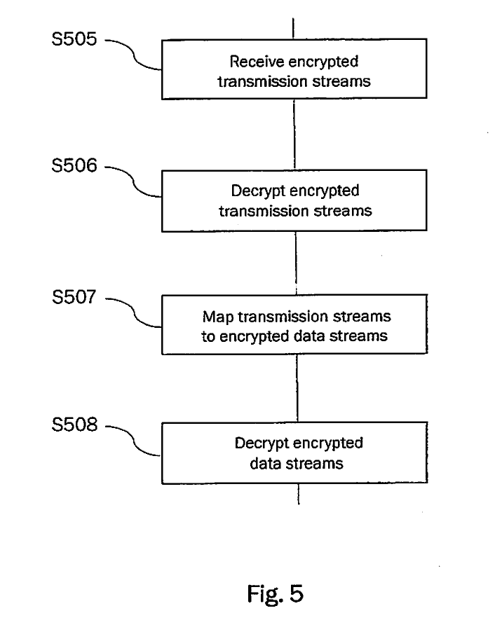

FIG. 5 is a flow chart schematically illustrating an example of a reception method according to embodiments of the disclosure. Notably, method steps of the reception method may correspond to the inverse of respective method steps of the transmission method described above with reference to FIG. 3.

At step S505, which is a reception step, a plurality of encrypted transmissions streams (corresponding to the encrypted transmission streams transmitted at step S504 in FIG. 3) may be received. Receiving may be performed by a plurality of optical reception units that may be in a one-to-one relationship with the plurality of encrypted transmission streams. The optical reception units may be sensitive to light at mutually different wavelengths, corresponding to the mutually different wavelengths of emission of the optical transmission units. Each optical reception unit may comprise an optical filter (color filter) that permits passage of a specific wavelength or wavelength band only, and a photodetector arranged behind the optical filter with respect to a received optical signal. Each optical filter may correspond to a respective one of the plurality of optical transmission units (e.g. colored LEDs). That is, light emitted by a given optical transmission unit may have a wavelength that lies in the passband of a corresponding optical filter, and lies in the rejection bands of the remaining optical filters. As an outcome of this step, a plurality of encrypted transmission streams are obtained.

At step S506, which is a first decryption step, each of the plurality of encrypted transmission streams may be decrypted. Decryption may be performed in accordance with a first decryption scheme, which may be the inverse of an encryption scheme of the second encryption step S503 described above. That is, the first decryption step may be the inverse of the second encryption step S503 described above. Decrypting each of the plurality of encrypted transmission streams may involve (un-)scrambling each of the plurality of encrypted transmission streams, e.g. by interchanging positions of symbols in each encrypted transmissions stream or by introducing appropriate phase shifts into each encrypted transmission stream. The changes of positions of symbols may be chosen to reverse any changes of positions of the symbols in the second encryption step S503 described above. Likewise., the phase shifts may be chosen to compensate for any phase shifts introduced in scrambling the plurality of transmission streams in the second encryption step S503 described above. Decrypting each of the plurality of encrypted transmission streams may also involve decrypting the respective encrypted transmission stream using an appropriate decryption algorithm. Each encrypted transmission stream may be decrypted individually. As an outcome of this step, a plurality of transmission streams are obtained.

At step S507, which is an (un-)rnapping step, the plurality of transmission streams obtained in step S506 may be mapped to a plurality of encrypted data streams. Each transmission stream may be mapped to at least two of the plurality of encrypted data streams. At this step, each encrypted data stream may be obtained as an interleaved sequence of data portions (e.g. blocks) of the plurality of transmission streams. This step may be the inverse of the mapping step S502 described above. For further details on mapping, reference is made to the above description with reference to FIG. 2B. As an outcome of this step, a plurality of encrypted data streams are obtained.

At step S508, which is a second decryption step, each of the plurality of encrypted data streams may be decrypted. Decryption may be performed in accordance with a second decryption scheme, which may be the inverse of an encryption scheme of the first encryption step S501 described above. That is, the second decryption step may be the inverse of the first encryption step S501 described above. Decrypting each of the plurality of encrypted data streams may involve (un-)scrambling each of the plurality of encrypted data streams, e.g. by interchanging positions of symbols in each encrypted data stream or by introducing appropriate phase shifts into each encrypted data stream. The changes of positions of symbols may be chosen to reverse any changes of positions of the symbols in the second encryption step S503 described above. Likewise, the phase shifts may be chosen to compensate for any phase shifts introduced in scrambling the plurality of data streams in the first encryption step S501 described above. Decrypting each of the plurality of encrypted data streams may also involve decrypting the respective encrypted transmission stream using an appropriate decryption algorithm. Each encrypted data stream may be decrypted individually. As an outcome of this step, a plurality of data streams are obtained.

The method may further comprise a decoding step (not shown in FIG. 5) at which each of the plurality of data streams obtained in step S508 may be decoded to a respective decoded data stream.

The method may yet further comprise an outputting step (not shown in FIG. 5) at which each decoded data stream or each data stream is output.

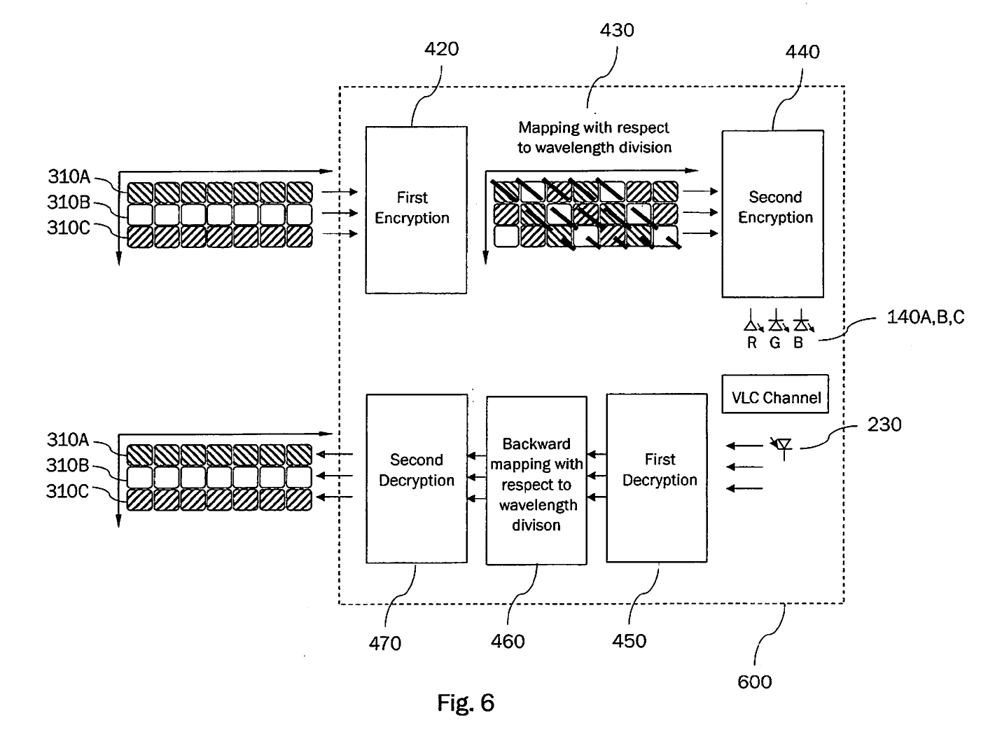

Next, a reception device according to embodiments of the disclosure will be described with reference to FIG. 6, which schematically illustrates an example of an integrated device 600 for transmission and reception. Notably, components of the integrated device 600 relating the reception as described in the next paragraph may be provided as parts of a stand-alone reception device.

Such reception device may comprise a reception unit, a first decryption unit 450, a mapping unit (un-mapping unit) 460, and a second decryption unit 470. The reception unit may comprise a plurality of optical reception units 230, as described above with reference to FIG. 1 and FIG. 5. The reception unit may be configured to perform the processing of step S505 described above. The first description unit 450 may be configure to perform the processing of step S506 described above. The first decryption unit 450 may comprise a plurality of first decryption sub-units (not shown in the figure), their number being equal to the number of encrypted transmission streams, each being configured to decrypt a corresponding one of the plurality of encrypted transmission streams. The mapping unit 460 may be configured to perform the processing of step S507 described above. The second decryption unit 470 may be configure to perform the processing of step S508 described above. The second decryption unit 470 may comprise a plurality of second decryption sub-units (not shown in the figure), their number being equal to the number of encrypted data streams, each being configured to decrypt a corresponding one of the plurality of encrypted data streams.

The integrated device 600 may further comprise components of the transmission devices described with reference to FIG. 4A or FIG. 4B, such as the first encryption unit 420, the mapping unit 430, the second encryption unit 440, and the transmission unit.

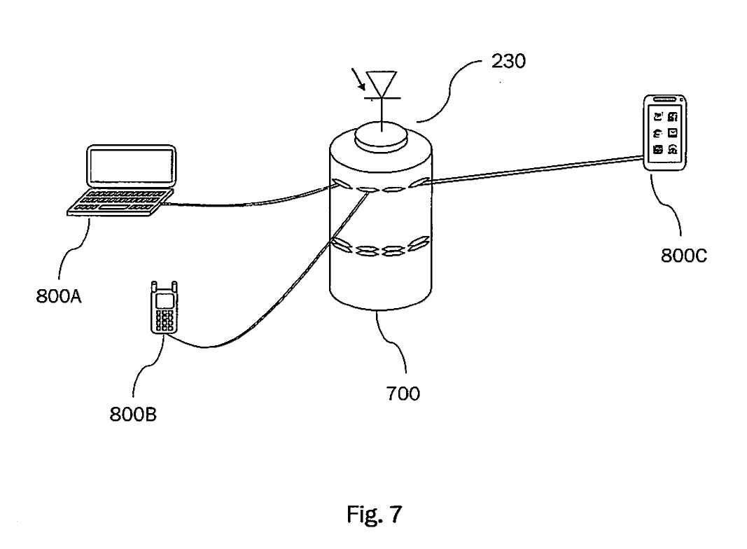

FIG. 7 schematically illustrates an example of a reception device (centralized reception device) 700 according to embodiments of the disclosure. The reception device 700 may comprise the components relating to reception described with reference to FIG. 6. The reception device may further comprise the components relating to transmission described with reference to FIG. 4A, FIG. 4B, or FIG. 6. The reception device 700 may further comprise connection ports for connecting to one or more user device 800A, 800B, 800C, e.g. via cable. Such cable-connections may employ the USB standard, for example. Each of the user devices 800 may receive an output data stream from the reception device 700. In case that the reception device No is provided also with transmission capability, each of the user devices 800 may provide an input data stream to the reception device 700 for subsequent transmission via WDM-VLC.

It should be understood that while the above description is made in terms of VLC, the present disclosure id not limited to communication using visible light, and relates in general to optical communication. Optical communication may proceed e.g. via infrared or ultraviolet light, in addition to visible light.

It should be noted that the apparatus features described above correspond to respective method features that may however not be explicitly described, for reasons of conciseness, and vice versa. The disclosure of the present document is considered to extend also to such method features and apparatus features, respectively.

It should further be noted that the description and drawings merely illustrate the principles of the proposed apparatus. Those skilled in the art will be able to implement various arrangements that, although not explicitly described or shown herein, embody the principles of the disclosure and are included within its spirit and scope. Furthermore, all examples and embodiment outlined in the present document are principally intended expressly to be only for explanatory purposes to help the reader in understanding the principles of the proposed apparatus. Furthermore, all statements herein providing principles, aspects, and embodiments of the disclosure, as well as specific examples thereof, are intended to encompass equivalents thereof.

1. A method of transmitting multiple data streams via multiple optical transmission units adapted for optical communication using wavelength division multiplexing, the method comprising:
a first encryption step of encrypting each of a plurality of data streams to obtain a respective encrypted data stream; and
a mapping step of mapping the plurality of encrypted data streams obtained in the first encryption step to a plurality of transmission streams for transmission via the optical transmission units, wherein the transmission streams and optical transmission units are in a one-to-one relationship, and wherein each transmission stream is mapped to by at least two of the plurality of encrypted data streams;
a second encryption step of encrypting each of the plurality of transmission streams to obtain a respective encrypted transmission stream; and
a transmission step of transmitting each of the plurality of encrypted transmission streams obtained in the second encryption step via a respective optical transmission unit.

2. The method according to claim 1, wherein in the first encryption step the plurality of data streams are encrypted individually, using a distinct encryption scheme for each data stream.

3. The method according to claim 1, wherein in the mapping step each transmission stream is obtained as an interleaved sequence of data portions of at least two of the plurality of encrypted data streams.

4. The method according to claim 1, wherein in the mapping step each of the plurality of encrypted data streams is mapped to each of the plurality of transmission streams.

5. A method of receiving multiple encrypted transmission streams via multiple optical reception units adapted for optical communication using wavelength division multiplexing, the method comprising:
a reception step of receiving a plurality of encrypted transmission streams at a plurality of optical reception units, wherein the received encrypted transmission streams and the optical reception units are in a one-to-one relationship;
a first decryption step of decrypting each of the plurality of encrypted transmission streams to obtain a respective transmission stream;
a mapping step of mapping the plurality of transmission streams obtained in the first decryption step to a plurality of encrypted data streams, wherein each transmission stream is mapped to at least two of the plurality of encrypted data streams; and
a second decryption step of decrypting each of the plurality of encrypted data streams to obtain a respective data stream.

6. The method according to claim 5, wherein in the second decryption step the plurality of encrypted data streams are decrypted individually, using a distinct decryption scheme for each encrypted data stream.

7. The method according to claim 5, wherein in the mapping step each encrypted data stream is obtained as an interleaved sequence of data portions of the plurality of transmission streams, such that for each transmission stream at least two of the plurality of encrypted data streams contain a data portion of the respective transmission stream.

8. A transmission device for transmitting multiple data streams via multiple optical transmission units adapted for optical communication using wavelength division multiplexing, the transmission device comprising:
a first encryption unit for encrypting each of a plurality of data streams to obtain a respective encrypted data stream; and
a mapping unit for mapping the plurality of encrypted data streams obtained by the first encryption unit to a plurality of transmission streams for transmission via the optical transmission units,
wherein the transmission streams and optical transmission units are in a one-to-one relationship, and wherein each transmission stream is mapped to by at least two of the plurality of encrypted data streams;
a second encryption unit for encrypting each of the plurality of transmission streams to obtain a respective encrypted transmission stream; and
a transmission unit for transmitting each of the plurality of encrypted transmission streams obtained by the second encryption unit, wherein the transmission unit comprises the multiple optical transmission units, and each encrypted transmission stream is transmitted via a respective optical transmission unit.

9. The transmission device according to claim 8, wherein the first encryption unit is configured to encrypt the plurality of data streams individually, using a distinct encryption scheme for each data stream.

10. The transmission device according to claim 8, wherein the mapping unit is configured to generate each transmission stream by sequentially interleaving data portions of at least two of the encrypted data streams.

11. The transmission device according to claim 8, wherein the optical transmission units are optical diodes emitting light at mutually different wavelengths.

12. A reception device for receiving multiple encrypted transmission streams via a plurality of optical reception units adapted for optical communication using wavelength division multiplexing, the reception device comprising:
a reception unit comprising the plurality of optical reception units, for receiving a plurality of encrypted transmission streams at the plurality of optical reception units, wherein the encrypted transmission streams and the optical reception units are in a one-to-one relationship;
a first decryption unit for decrypting each of the plurality of encrypted transmission streams to obtain a respective transmission stream;
a mapping unit for mapping the plurality of transmission streams obtained by the first decryption unit to a plurality of encrypted data streams, wherein each encrypted data stream is mapped to by at least two of the plurality of transmission streams; and
a second decryption unit for decrypting each of the plurality of encrypted data streams to obtain a respective data stream.

13. The reception device according to claim 12, wherein the second decryption unit is configured to decrypt the plurality of encrypted data streams individually, using a distinct decryption scheme for each encrypted data stream.

14. The reception device according to claim 12, wherein the mapping unit is configured to generate each encrypted data stream by sequentially interleaving data portions of the transmission streams, such that for each transmission stream at least two of the plurality of encrypted data streams contain a data portion of the respective transmission stream.

15. The reception device according to claim 12, wherein each optical reception unit comprises a photodetector and an optical filters, wherein the optical filters of the multiple optical reception unit have mutually different pass bands.
